(19) United States
(12) Patent Application Publication
(10) Pub. No.: US 2024/0253279 A1
(43) Pub. Date: Aug. 1, 2024

(54) PROTECTIVE TRAYS WITH HIGH DENSITY OF STORAGE

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/477,343

(22) Filed: Sep. 28, 2023

Related U.S. Application Data
(60) Provisional application No. 63/481,901, filed on Jan. 27, 2023.

(51) Int. Cl. B29C 44/44; B29C 44/34

(52) U.S. Cl. CPC B29C 44/445; B29C 44/3415; B29K 2067/046; B29K 2995/0072; B29K 2995/0097

(57) ABSTRACT

Bead-foam articles suitable for use as high-density product packaging and methods for forming high-density product packaging are provided. The bead-foam articles include a plurality of cavities separated by a plurality of walls and advantageously increase the number of products that may be stored, shipped, and/or displayed in a given package without sacrificing protective characteristics such as vibration protection, impact protection, or protection from external elements.

### CROSS-REFERENCE TO RELATED APPLICATION

This application claims priority to U.S. Provisional Application No. 63/481,901, filed Jan. 27, 2023, which is incorporated herein by reference.

### FIELD OF THE DISCLOSURE

This disclosure relates generally to molded bead-foam articles and, in particular, relates to the molded bead-foam articles formed from polylactic acid such as trays configured to store, protect, and transport many products at once.

### BACKGROUND

Product packaging serves as vibration protection, impact protection, and external packaging for product identification. These functions must be preserved while reducing the weight, size, carbon footprint, and material usage associated with consumer, medical, and industrial goods. In particular, high-density storage associated with shipping bulk goods to big-box stores or shipping product constituents from one manufacturing step to the next manufacturing step involves forming packaging capable of securing several articles simultaneously. Such high-density product packaging, sometimes referred to as “trays” because they often take the form of stackable trays, must be robust enough to protect the products, but would ideally be thin enough to maximize the number of products that may be shipped in a single package. FIG. 1A, for example, depicts a polyurethane foam insert with horizontal cavities. The number of products within this product packaging is limited by the thickness of the walls between each product, and the thickness of the walls between each product is determined by the material and process used to form the walls.

The trays used in high-density product packaging are characterized by a plurality of cavities separated by a plurality of walls. These cavities typically have the shape of the product intended to be packaged, or else may have a generic shape suitable for the product, such as an approximately rectangular cavity. Since a remarkably high number of products rely on high-density product packaging for one or more steps in the manufacturing and distribution process, there is no “one size fits all” product packaging. Instead, each product packaging must be custom-made for the products intended to be stored within. Thus, molding processes are preferred for high-throughput packaging manufacturing.

Molding product packaging involves ejecting the part from the molding machine, which requires forming the product packaging to have a taper so that it may be removed from the molding machine. It is challenging to mold product packaging with the degree of taper necessary to form effective product packaging. Typical injection molding, thermoforming, molded pulp, and bead foam molding processes are unable to eject parts having a taper of 1° or less. Furthermore, increasing the depth of the mold cavity reduces the likelihood that a usable part can be molded because increased depth, while maintaining the taper necessary to enable ejection, increases the overall size of the product packaging. Further still, typical molding processes cannot create molded material having thin side walls, so the goals of reducing material usage and product packaging size remain elusive.

The carbon footprint of product packaging is two-fold: both the emissions created by the formation of the product packaging and the emissions associated with transportation of the product packaging (before and after being loaded with the relevant product). Both emission-generating steps must be considered in any feasible solution to the impact on the environment. For example, a hypothetical product packaging that reduces the carbon footprint associated with forming the product packaging but increases the carbon footprint associated with transporting the product packaging is not an overall improvement to existing techniques. Recent analyses of the carbon footprint of product packaging have shown that primary and secondary packaging (packing for individual articles and packaging for groups of packaged articles), transportation, and storage account for 20-30% of the total carbon footprint of common articles at “big box” stores. Solutions that minimize packaging size stand to reduce this carbon footprint by around 50%, thereby impacting 15-20% of total carbon footprint without any change to the product or product manufacturing process itself.

However, previous attempts to reduce the carbon-footprint of product packaging have failed for one reason or another. High-density storage solutions require product packaging that is custom for the products stored therein. As such, molding the product packaging is typically necessary so that irregular, custom shapes may be formed. However, the molding process itself limits the critical dimensions of the resulting packaging. As a cavity's depth increases, the ability to eject the packaging from the mold forces the taper to increase, thereby limiting the ratio of depth to effective hydraulic diameter to around 2 for thin wall packaging. Molding packaging with sufficient rigidity to facilitate handling means forming packaging with thick walls, resulting in increased material usage, increased weight, and increased volume (leading to fewer packages being shipped in any given volume of shipment). On the other hand, reducing weight and material usage produces thin walls that are less effective as protective insulation and as a “tray” that may be stacked for high-density storage. This trade-off may be partially mitigated by increasing the density of the molded packaging, but any improvements to the carbon-footprint of smaller and stronger packaging is offset by the increased weight that comes with the increased density.

Attempts to form product packaging from expandable polystyrene (EPS), such as the one depicted in FIG. 1B, are limited by the size of the foam beads used to form the packaging. The maximum size of shape-molded EPS-based articles is dependent on the bead size. Thinner walls within an EPS-based molded article can only be achieved with smaller articles that would not be suitable for large high-density product packaging. In general, the minimum thickness limit is 3-5 beads thick and the maximum thickness limit is 40-60 beads thick. The maximum thickness limit decreases when a plurality of walls are in the molded EPS-based article. Molded articles with a plurality of walls made with small EPS beads have a higher limit for packaging thickness, around 0.5 inches, and prevents forming packaging with deep cavities, further limiting the use-cases for EPS-based product packaging. Furthermore, EPS-based packaging has further undesirable characteristics such as poor recyclability, reliance on petrochemicals, and the presence of volatile organic compounds such as pentane during the EPS molding process.

Attempts to form product packaging from expandable polypropylene (EPP), such as the ones depicted in FIG. 1C and FIG. 1D, involves producing foam beads from 5/32 to ¼ inch in diameter, which is relatively large compared to other molded foam packaging. Because of the large beads used to form EPP articles, the distance between cavities has an increased minimum distance compared to even small-bead EPS. Furthermore, EPP processing involves higher pressures during the molding process which limits the depth of cavities formed in the product packaging, and the taper of the packaging walls is typically 2° or greater.

Attempts to form product packaging from molded pulp or corrugated cardboard typically suffer from rough side walls, and deep cavities cannot be formed. These rough sidewalls present challenges with abrasiveness and may scratch the products stored in the packaging. Since molded pulp is formed from dried fibrous material, molded pulp is also prone to shedding “dust” in the form of these dried fibers, especially after repeated product loading and unloading. The fibrous material of molded pulp or corrugated packaging is also prone to changing dimensions and impact protection based on the humidity. The taper in molded pulp product packaging is typically 4° or greater, further reducing molded pulp's effectiveness as high-density product packaging, especially for larger articles.

Attempts to form product packaging from thermoformed polyethylene terephthalate (PET), polyvinyl chloride (PVC), or polypropylene (PP) all suffer from an inability to form deep cavities. Increasing cavity depth in these materials results in significant drops in structural rigidity resulting in flimsy packaging. Furthermore, controlling the dimensions and protective properties of individual cavities within the product packaging is challenging. Small changes in, for example, the amount of vacuum applied during the molding step results in large differences in the cavity size.

Further still, manufacturing techniques such as thermoforming, injection molding, and molded pulp do not enable the formation of supports or imprinted features on the sides of the packaging for use as grips by a user.

Attempts to form product packaging from polyethylene (PE) typically rely on cutting and adhering many thin foam layers. However, these cut pieces present recycling challenges depending on the adhesive used, and each cut piece results in some amount of wasted material. Because PE foam has a low compression modulus, forming effective PE-based packaging requires considerable spacing between the cavities (i.e., thicker walls) and a much larger tray than other materials to ensure the products are protected. As a result, the carbon footprint associated with shipping PE-based packaging is greater than other materials, to say nothing of the increased waste produced in the packaging manufacturing itself.

Attempts to form product packaging with injection molding, such as the one depicted in FIG. 1E, presents challenges with achieving suitable vibration and impact protection for the resulting packaging. The depth of cavities produced by injection molding is limited based on the thickness of the walls forming the cavity. The ratio of depth to wall thickness in articles produced by injection molding is around 300, but only if the total number of cavities does not exceed around 6 cavities. Thus, injection molding requires a trade-off between depth of cavities and thickness of the overall packaging.

Attempts to form product packaging using lathe machining, such as the one depicted in FIG. 1F, typically have wide flexibility for the depth and taper of cavities, but cavity formation results in substantial material waste and the production of airborne particulates necessitating waste cleanup, air purification, and some sort of personal protective equipment to prevent damage to worker lungs. Forming smooth sidewalls, although possible, requires much longer because the lathe must move slower to form smooth sidewalls.

Attempts to form product packaging using corrugated plastic, such as the one depicted in FIG. 1G, suffer from very poor rigidity so an additional outer structure is necessary. This outer structure is often heavier than the inner structure so that using corrugated plastic is not a feasible solution to reducing the weight of product packaging.

Some high-density product packaging utilizes multiple materials to capture benefits of both, such as a high-density material for maintaining product orientation in a package with a low-density material for preventing the products from impacting neighboring products, such as the packaging in FIG. 1H. However, this requires each product to be in the same plane and doubles the manufacturing complexity.

These challenges are particularly acute in the transportation of therapeutic and biological articles. As depicted in FIG. 2A, transportation of test tubes or diagnostic tubes is commonly achieved using a shallow array of cavities. However, unless these cavities are filled symmetrically or very carefully, the tray is unsteady and susceptible to tipping over. To address the tipping, other transportation solutions such as the one in FIG. 2B produce deeper cavities, but at the cost of product density so that additional packaging is needed to ship the same number of products. Still other solutions, such as the one in FIG. 2C, rely on adhering multiple layers of PE foam followed by machining the foam. However, this solution limits recyclability and creates waste during machining.

Another product packaging for glass vials is depicted in FIG. 2D, which uses a PE foam insert and arranges the vials horizontally. However, this packaging sacrifices around 50% of the packaging volume to the PE foam.

Another product packaging for glass vials is depicted in FIG. 2E, which depicts two packages stacked on one another. This approach relies on injection molding but again sacrifices around 50% of the packaging volume to the injection molded plastic.

Another product packaging for glass jars is depicted in FIG. 2F, which relies on starch. Although this approach is “ecofriendly,” it consumes more carbon-rich resources during transportation than the savings realized from producing the packaging from starch.

Accordingly, improved high-density product packaging and methods of making high-density product packaging are needed for overcoming one or more of the technical challenges described above.

### BRIEF DESCRIPTION OF THE DRAWINGS

The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIGS. 1A-1H depict product packaging in the prior art.

FIGS. 2A-2F are product packaging for glass containers in the prior art.

FIGS. 3A-3B show a molded bead-foam article in accordance with the present disclosure.

FIGS. 4A-4D show a molded bead-foam article in accordance with the present disclosure.

FIGS. 5A-5B show a molded bead-foam article in accordance with the present disclosure.

FIGS. 6A-6D are product packaging for glass vials in the prior art.

FIGS. 7A-7C show schematics for molded bead-foam articles in accordance with the present disclosure.

FIG. 8 is a copper cylinder for forming cavities in accordance with the present disclosure.

FIG. 9 shows a molded bead-foam article in accordance with the present disclosure.

FIGS. 10A-10D show a molded bead-foam article in accordance with the present disclosure.

FIGS. 11A-11B show cavity-to-wall size comparisons in accordance with the present disclosure.

FIGS. 12A-12G show exemplary molded bead-foam articles in accordance with the present disclosure.

FIGS. 13A-13B show product packaging in the prior art.

FIG. 14 shows a molded foam product packaging in accordance with the present disclosure.

FIGS. 15A-15B show a molded bead-foam article in the prior art.

FIGS. 16A-16B show a molded bead-foam article in accordance with the present disclosure.

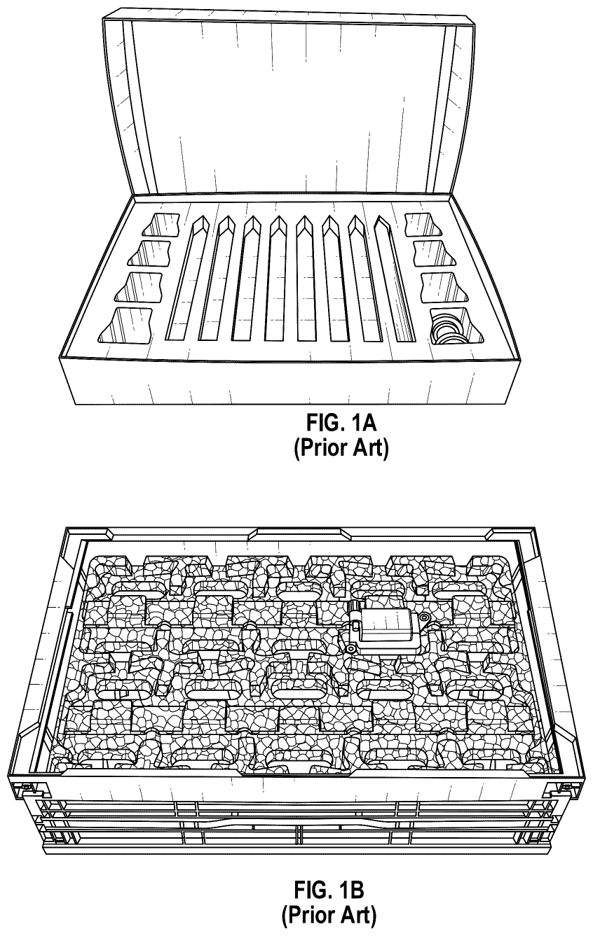

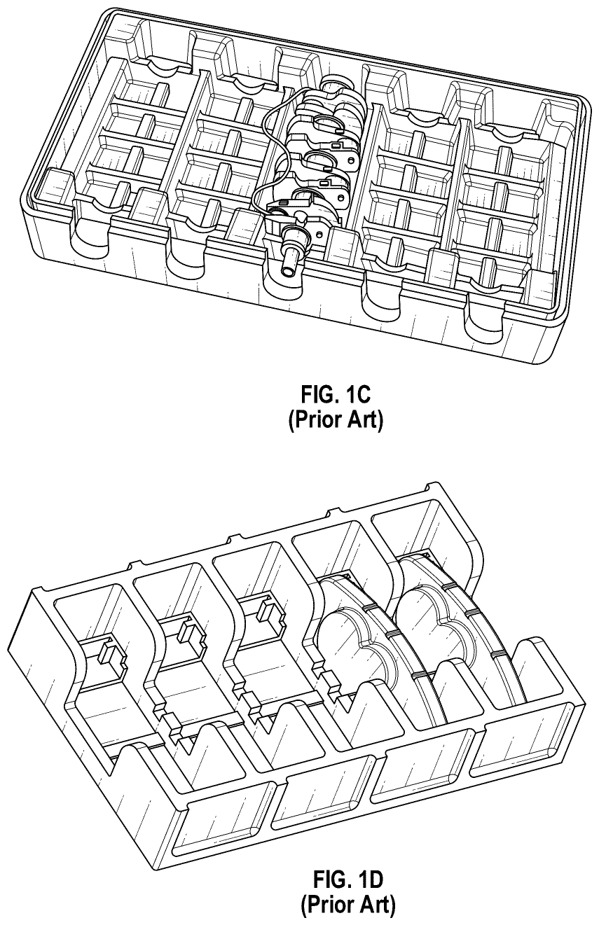

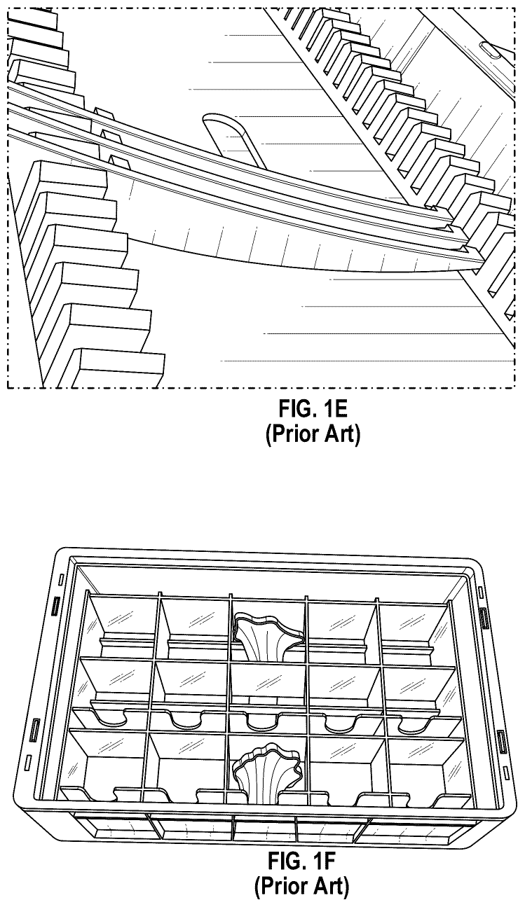

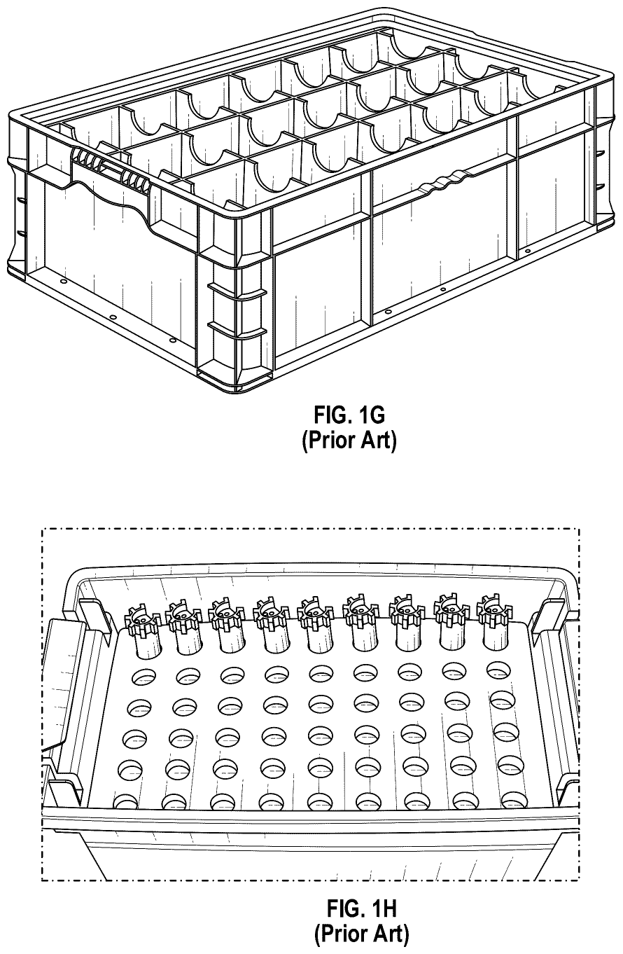

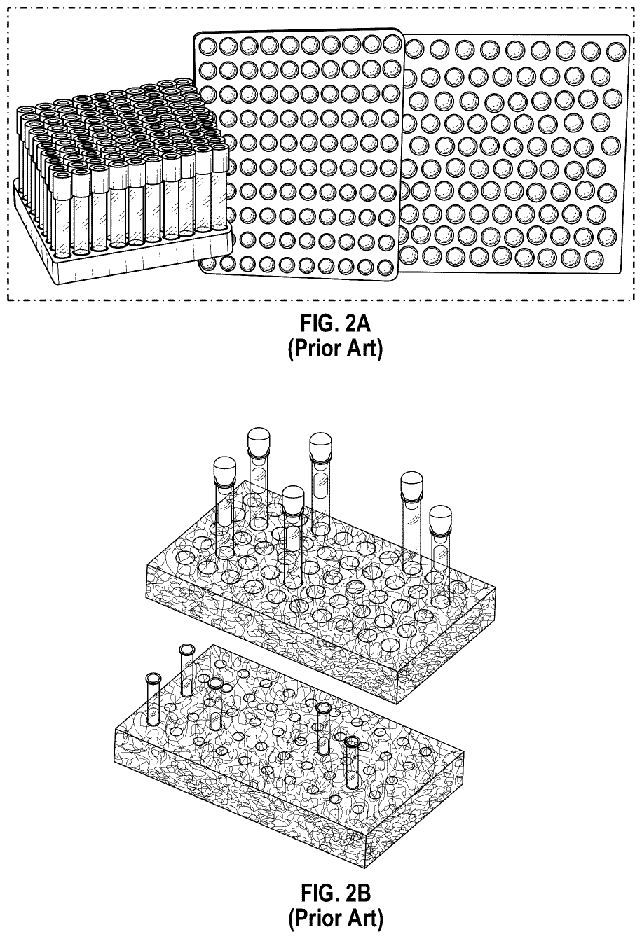

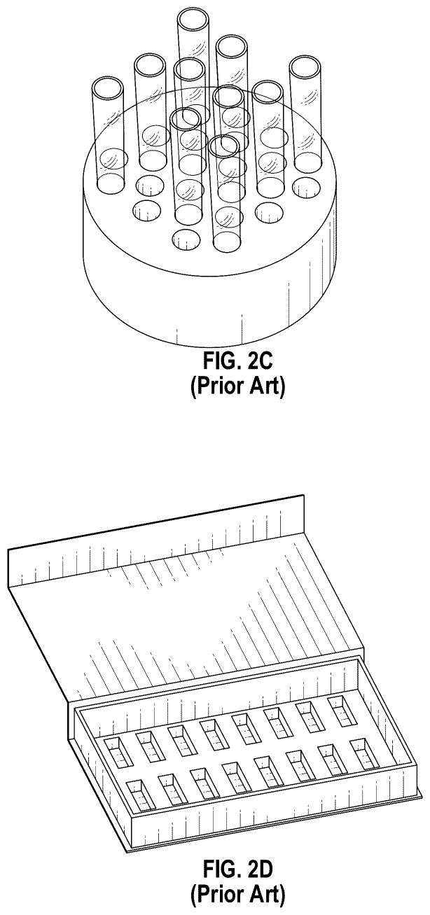

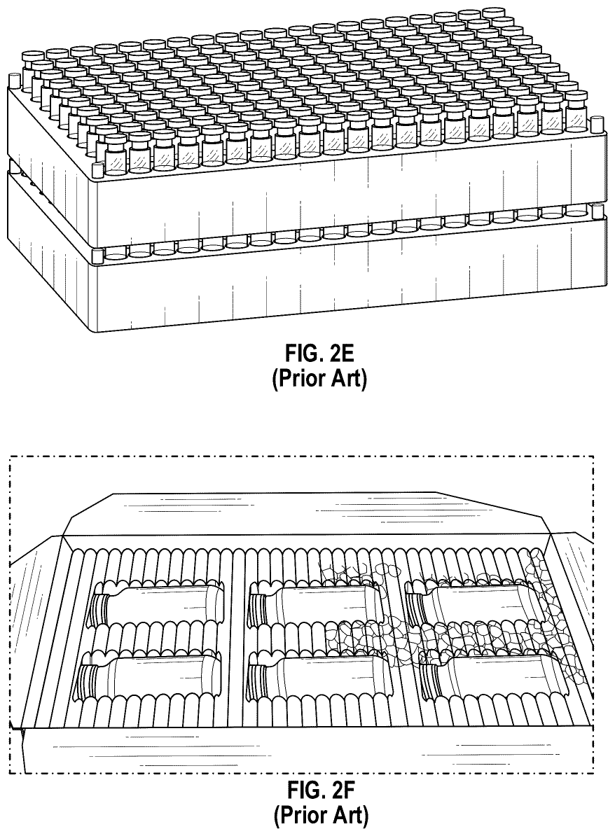

### DETAILED DESCRIPTION

Molded bead-foam articles and methods of making molded bead-foam articles are provided herein including molded bead-foam articles formed from polylactic acid having a plurality of cavities separated by a plurality of walls. In particular, it has been unexpectedly discovered that forming the molded bead-foam article from polylactic acid bead-foam advantageously enables the formation of deeper cavities separated by thinner walls with steeper taper, enabling an overall reduction in material usage, reduction in packaging weight, increase in structural strength and flexural strength, and reduction in carbon footprint associated with product packaging manufacturing, transportation, and storage.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the terms “about” and “approximately” with reference to dimensions refers to the dimension plus or minus 10%.

### Molded Bead-Foam Articles

Molded bead-foam articles are disclosed herein. In some embodiments, the molded bead-foam articles are formed from expandable polylactic acid (PLA). In some embodiments, producing the molded bead-foam article may be performed according to the methods described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC, each of which are incorporated herein by reference in their entirety. By forming the molded bead-foam articles from PLA, the molded bead-foam articles are biodegradable and compostable.

In some embodiments, the molded bead-foam articles include a first plurality of cavities separated by a plurality of walls. High-density product packaging, also known as “trays”, are characterized by a plurality of cavities having a shape that complements the product intended to be packaged. By forming molded bead-foam articles from polylactic acid, the packaging is compostable, reducing the formation of waste.

In some embodiments, at least one wall in the plurality of walls is less than 3 foam beads thick. Molded bead-foam articles are commonly described as having a thickness defined by the number of foam beads that are fused together to form the molded bead-foam article. For example, EPS-based bead-foam articles typically have a minimum wall thickness between the cavities of 5 beads. When EPS-based foam beads are used to produce high-density vertical cavity trays, small EPS beads known as “cup beads” or “t-size” beads are used. These “cup beads” require expensive bead molding equipment and produce trays having sizes limited to 8″×8″×1″ with maximum wall thickness of ½″ without sacrificing bead fusion quality. The small EPS bead size limits fusion of the beads and therefore limits the maximum size of the trays and prevents scaling of the process to larger and/or thicker trays. In contrast, forming the molded bead-foam article from PLA may involve the formation of an article having a minimum wall thickness of 3-5 beads thick with a rough surface, which can subsequently be compressed to a thickness of 1-2 beads thick or less without sacrificing structural integrity and resulting in a smooth surface. In some embodiments, at least one wall in the plurality of walls is 1/16 inch thick or less.

In some embodiments, at least one wall in the plurality of walls has a taper of about 0.5° or less. When molded bead-foam articles are formed in a mold, it may be challenging to produce a taper of 0°, which corresponds to a side wall being perfectly vertical, because the molded article must be ejected from the mold. However, a side wall having a 0° taper hypothetically provides the most secure fit for a given product. Furthermore, a lower side wall taper enables denser article packaging while preventing the articles from contacting each other, a common side-effect of typical high-density packaging having a taper of 3° or more. Furthermore, a taper of 0-0.5° enables deeper cavities because less space is taken up by the base of walls and eliminates the need for packing on top of the stored products. Further still, the low taper and ability to create cavities of any depth enable the formation of cavities having multiple depths in a single tray to facilitate suitable packaging of more uniquely shaped products, such as products having a flange. In some embodiments, cavities with multiple depths may be exploited to allow more dense packing of articles having multiple widths, including stacking of one end of a first product over an end of a second product. Thus, it is advantageous to minimize the taper of the walls. It has been unexpectedly discovered that forming the molded bead-foam article from PLA enables a taper of 1° or less, a feature that has not yet been produced using traditional methods such as injection molding, thermoforming, or molded pulp, and have not yet been produced by molding traditional expandable foam beads such as EPS, EPP, or PE.

In some embodiments, at least one cavity in the plurality of cavities has a ratio of depth to hydraulic diameter of 2.5 or greater. As used herein, the “hydraulic diameter” is used to describe non circular cavities such as square, triangular or other shaped cavities and define them by their equivalent “round” cavities by using the area and perimeter of the non-circular shape to compute hydraulic diameter. Conventional molding techniques, including molding expandable beads formed from EPS, EPP, or EPE, are typically limited to a depth-to-hydraulic-diameter ratio between 2 to 2.5. It has been unexpectedly discovered that forming the packaging from PLA enables the formation of cavities with higher aspect ratios suitable for a wider range of products. In some embodiments, at least one cavity in the plurality of cavities has a depth to hydraulic diameter of at least 2.

In some embodiments, at least one wall in the plurality of walls is smoother than a comparable EPS, EPP, or PE-based molded article. It has been unexpectedly discovered that forming the product packaging from PLA produces walls that are very smooth. Smoother walls reduce friction between the packaging and the product itself, enabling even smaller tapers in the walls. If there is friction between the walls and the product, a low-taper cavity will generate additional friction with the product when the product is removed. This forces the user, operator, or robotic implement to use greater force and, in most cases, a counterforce against the product packaging in order to remove the product from the product packaging. Notwithstanding the challenges in forming low-tapered cavities, described above, low-taper cavities are further undesirable when the walls are not smooth. Furthermore, the friction experienced by the product will often produce dust or foam particulates as the product is removed from the packaging because the friction will tear away the pieces of the product packaging responsible for the “rough” feeling. Forming the product packaging from EPS, EPP, or PE does not enable the formation of low-taper cavities with smooth sidewalls without secondary processes such as lathe machining and, in some cases, tertiary processes such as sandpaper. In contrast, by forming the product packaging from PLA, the material that would otherwise be lost as dust is formed into a “skin” as described below.

In some embodiments, the cavity has a cylindrical shape, a rectangular shape, a triangular shape, an oval shape, or any other suitable shape depending on the shape of the product intended to be stored in the product packaging.

In some embodiments, the molded bead-foam article includes a skin-formed portion on the bottom of at least one cavity in the plurality of cavities and/or at least one wall in the plurality of walls. As used herein, a “skin-formed” surface or portion of a surface is one that has gone through a “skin-forming” process by which the portion of the surface is exposed to sufficient heat, optionally with the application of pressure, so that the molded beads at the surface of the molded bead-foam article experience a heightened degree of fusion and densification compared to the beads in the interior of the molded bead-foam article. Skin-forming results in a smoother surface compared to a surface that has not been skin-formed, and the skin-formed surface imparts heightened compressive strength and flexural strength to the molded bead-foam article compared to a molded bead-foam article without a skin-formed surface. It has further been unexpectedly discovered that skin-forming can be performed on curved or irregular surfaces, enabling these mechanical and thermal enhancements on surfaces that were previously incapable of enhancements, even by conventional means. Further still, cavities including even a very thin skin-formed portion enables repeated insertion and removal of products, upwards of 100 insertion/removal cycles or more without wear or damage to the cavity.

Conventional EPS molding processes produce an EPS-based molded foam article incapable of being skin-formed because of the presence of pentane blowing agent within the EPS beads. Performing a skin-forming process on freshly molded or, in some cases, up to 72-hour aged EPS-based molded foam articles results in either overexpansion of the beads that form the molded article surface, or a contraction of cells that subsequently forms a weak skin, deteriorating the mechanical properties of the article. If a particular compressive resistance, tensile strength, or flexural strength is desired in an EPS-based molded foam article, the density of the foam must be increased. Similarly, if a particular foam density and/or weight are desired in an EPS-based molded foam article, some degree of compressive resistance or flexural strength must be sacrificed. A high compressive strength and modulus in an EPS-based molded foam article is only achievable at densities of at least 2 pcf, even as high as 4 pcf. In contrast, the skin-formed surface of the PLA-based molded bead foam article of the present disclosure has the same compressive strength and modulus at a density of only 1.6-1.8 pcf, further enabling realization of product packaging with sufficient protection of products stored within without substantially increasing the weight and/or size of the product packaging itself. In some embodiments, the skin-formed portion of the at least one surface has a density of between about 1.0 pcf and about 6.0 pcf.

In some embodiments, at least one product is stored in each cavity in the plurality of cavities. In some embodiments, when each cavity is loaded with a product, the packing density of the products is greater than any comparable product packaging produced by injection molding, molded pulp, bead foam molding, or thermoforming for the reasons described above. It has been unexpectedly discovered that by forming the product packaging from PLA-based foam beads, thinner walls can be produced having smaller degrees of taper without sacrificing structural integrity. As a result, the density of products stored in the packaging is dramatically increased while maintaining or improving the impact protection for those products, and while maintaining or reducing the footprint of the packaging. When more products can be shipped in a given space, fewer product packages are needed for a given number of products and fewer shipments are needed for a given number of products, so the carbon footprint associated with the product is reduced by both a measure of transportation costs and product packaging costs.

In some embodiments, the molded bead-foam article includes a second plurality of cavities having a depth axis perpendicular to a depth axis of the first plurality of cavities. In other words, some products may be stored in the first set of cavities in a “downward” direction, and some products may be stored in the second set of cavities in a “sideways” direction. For some irregularly shaped products, such as products having a tapered or cone shape, the product packaging necessary to securely store and transport those products may require cavities with large openings but much smaller cushioning at a point deep within the cavity. This leaves a large amount of unused volume within the product packaging. Because the cavities in a PLA-based molded bead-foam article may be formed after molding by pressing a shaped platen with a plurality of cavity-forming structures against the article, a second plurality of cavities may be formed perpendicular to the first plurality of cavities. For example, certain medical treatments require two or more medications, reagents, or the like that are administered in series or combined prior to administration. By forming a second plurality of cavities, each vial necessary for a medical treatment may be included in a single bead-foam article as a “kit”, simplifying distribution of the medication and reducing the likelihood that the medication is delivered to a user or patient without any one of the reagents.

In some embodiments, at least one cavity in the first plurality of cavities has a depth that is different from a depth of at least one other cavity in the first plurality of cavities. Conventional product packaging is limited to relatively shallow cavities, as described above, while the PLA-based product packaging described herein can have significantly deeper cavities. With this increased capability to deepen the cavities comes the ability to form cavities having multiple depths, such as cavities suitable for cylindrical products having flanges, over-sized stoppers or membrane separators. Turbomolecular pumps, for example, typically have a steel flange for securing the pump to a vacuum chamber; the steel flange has a larger diameter than the pump chassis. These turbomolecular pumps therefore require custom packaging capable of securing the pump around the pump chassis and the steel flange. By forming the product packaging from PLA, products such as these pumps can be secured in PLA-based packaging that is lighter and stronger than conventional packaging.

In some embodiments, the molded bead-foam article includes at least one grip portion having a depth axis perpendicular to a depth axis of the first plurality of cavities. In some embodiments, these grips are formed as part of the molding process. In some embodiments, the grips are formed without glue or fixtures. In some embodiments, the grips are formed by pressing a heated platen having a protrusion corresponding to the shape of the grip against the molded bead-foam article. In some embodiments, the grip is formed without generating dust and without subtractive machining.

In some embodiments, at least one cavity in the first plurality of cavities has at least one hole in the bottom of the cavity. Forming the product packaging from PLA enables a lower degree of taper, as described above, and this creates a more secure fit for products stored within. The more secure fit may result in a “pillow” effect when the product is inserted into the cavity and a “vacuum” effect when the product is removed from the cavity until air is permitted to pass around the product into or out of the cavity. By forming a hole in the bottom of the cavity, it is easier to insert and remove a product from the cavity because air is permitted to enter and/or exit. In some embodiments, at least one cavity in the first plurality of cavities has at least one keyhole slot in a wall of the cavity. As used herein, a “keyhole slot” refers to a channel formed in the wall of the cavity that allows air to enter and exit the cavity during product insertion or removal.

In some embodiments, the molded bead-foam article includes a supplementary molded foam feature that is attached to the molded bead-foam article. By forming the molded bead-foam article from PLA, supplementary PLA-based bead-foam articles may be readily attached to the PLA-based packaging by heating the surface of the PLA articles, a property unique to PLA-based molded bead foam articles. For example, the supplementary molded foam feature may be an additional wall to subdivide a molded cavity into one or more smaller cavities. The supplementary molded foam feature may be used to thicken an existing wall to better suit a particular product. The supplementary molded foam feature may be an additional plurality of cavities and walls that can be affixed to an existing molded bead-foam article to increase the number of cavities.

### Methods of Forming Molded Articles

Methods of forming molded articles are also described herein. In one aspect, the methods include forming any of the molded bead-foam articles described above. In another aspect, the methods include molding a plurality of foam beads formed from polylactic acid. In some embodiments, the molding process includes injecting the plurality of foam beads into a mold and subjecting the mold to an elevated temperature and/or reduced pressure to expand the foam beads. In some embodiments, the molding process may be performed according to the methods described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC. In some embodiments, the molded bead-foam article produced by this method is characterized by having a plurality of cavities separated by a plurality of walls.

In some embodiments, the plurality of cavities is at least partially formed by a plurality of corresponding cavity-forming structures in the mold. In some embodiments, the cavity-forming structures in the mold are exclusively responsible for forming the cavities. For example, the cavity-forming structures may be columns or pillars having a cross-sectional shape and taper suitable for forming the desired cavity dimensions. In some embodiments, the cavity-forming structures may be responsible for forming only a partial portion of the cavities so that the cavities may be more easily formed and finalized in a subsequent step.

In some embodiments, the method includes pressing a shaped platen against the molded bead-foam article. In some embodiments, the shaped platen includes a plurality of cavity-forming structures so that the plurality of cavities is at least partially formed by the shaped platen. For example, the molded bead-foam article may have a flat surface so that, when the shaped platen is pressed against the molded bead-foam article, the cavity-forming structures in the shaped platen are exclusively responsible for forming the cavities. In other embodiments, the molded bead-foam article may have a plurality of partially formed cavities as a result of the molding step and pressing the shaped platen against the molded bead-foam article results in fully formed cavities. In some embodiments, the platen is pressed against the molded bead-foam article with a pressure of 100 psi or less. In some embodiments, the shaped platen is heated before being pressed against the molded bead-foam article. Because the cavities may be formed in the molded bead-foam article exclusively after molding, a molded bead-foam article may be used for forming packaging at the same location as product packaging. Furthermore, since PLA-based molding techniques can form foam panels of significantly larger thicknesses compared to EPS, EPP, or PE-based bead-foam articles, the resulting “tray” can be several times larger, with significantly more cavities, and with superior strength and toughness, than trays formed from other bead foams.

In some embodiments, the method includes attaching one or more supplementary foam features to the molded bead-foam article to form one or more additional cavities.

### EXAMPLES

### Example 1: Producing Cavities in PLA-Based Bead-Foam Article Using Heated Cylinder

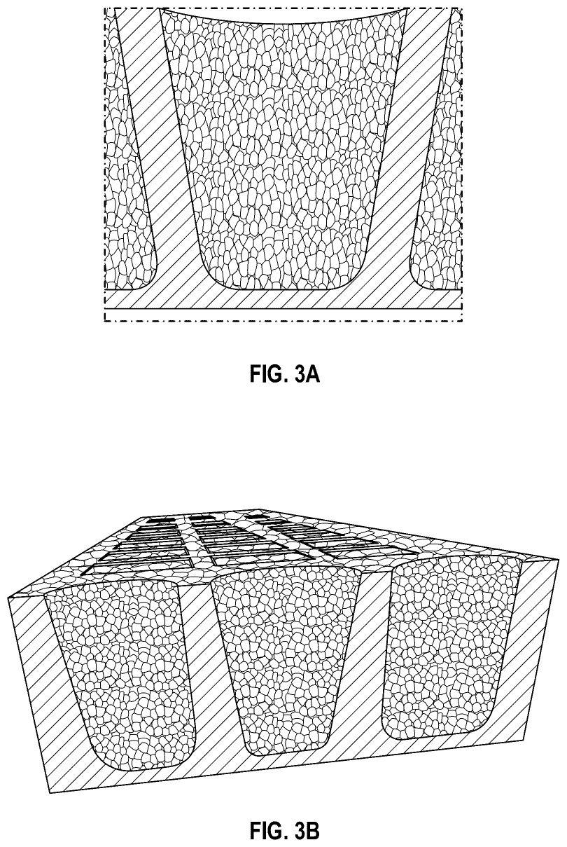

A molded bead-foam article as described herein was produced using PLA-based foam beads with graphite additives. The mold did not include cavity-forming structures, so the molded bead-foam article exiting the mold had a flat, uninterrupted surface. An aluminum shaped platen having three 0.875-inch cylinders was heated using a heat gun to between 300-400° F. and pressed against the molded bead-foam article. Each resulting cavity had a width of 11/16 inches and a depth of 1 inch. The three-cylinder platen was reheated and pressed against the molded article 15 times to create a “tray” with 45 cavities. The base of the cavity was 1/16 inches thick, and the taper of the walls was 5 degrees. The overall dimensions of the 45-cavity tray were 12 inches long. 2 inches wide, and 1 inch high. Cross-sectional views of this tray are displayed in FIGS. 3A and 3B.

### Example 2: Producing High-Aspect Ratio Cavities

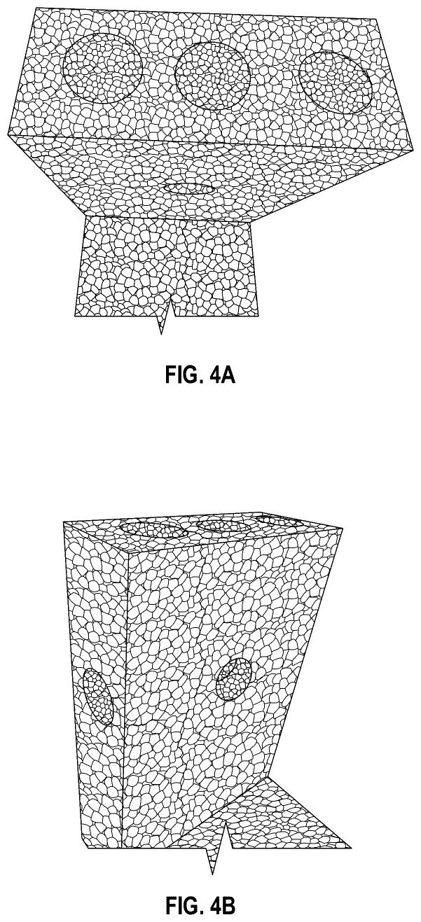

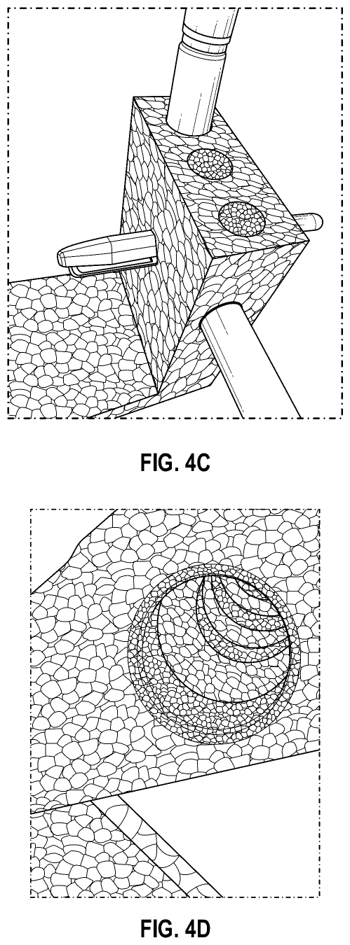

A molded bead-foam article was produced as described herein using PLA-based foam beads. The mold did not include cavity-forming structures, so the molded bead-foam article exiting the mold had a flat, uninterrupted surface. An aluminum cylinder 11/16 inches in diameter was pressed against the molded bead-foam article and inserted 4¾ inches, producing a cavity 4¾ inches deep with a diameter of 11/16 inches, which is a depth-to-diameter ratio of 7. Because the cylinder was not tapered, the resulting cavity had a 0° taper. The resulting article is displayed in FIGS. 4A and 4B. Cavities with such depth-to-diameter ratios and taper have not been produced with other molding techniques.

After forming this first plurality of cavities, the aluminum cylinder was heated again and pressed against the side of the molded bead-foam article to form a second plurality of cavities having a depth axis perpendicular to the depth axis of the first plurality of cavities. To better illustrate this, markers were inserted into the cavities and the results are displayed in FIGS. 4C and 4D. Perpendicular cavities such as these have not been possible with other molding techniques and have instead required lathe machining to form, a more expensive process that results in wasted material and the production of foam dust particles.

### Example 3: Producing Keyholes in Cavities

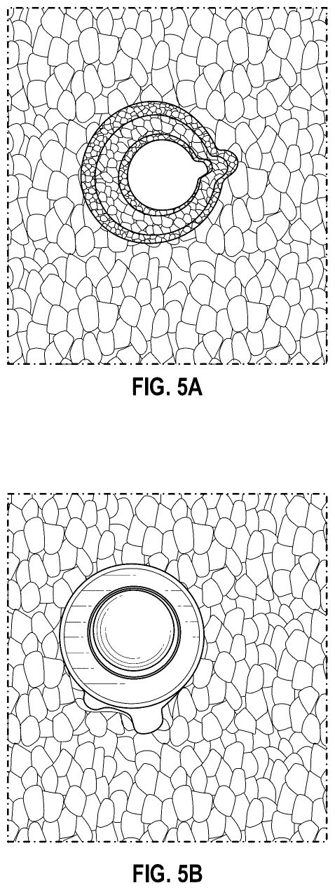

The molded bead-foam article of Example 2 was modified with a “keyhole” slot configured to enable air passage during product insertion and removal. The result is displayed in FIG. 5A; FIG. 5B displays the cavity with a battery inserted to illustrate the resulting space created. As shown in FIGS. 5A and 5B, the inclusion of a keyhole slot enables the formation of a cavity having a very tight tolerance, ensuring a secure and low vibration fit for the product.

### Example 4: High-Density Test-Tube Holder Resilient to Tipping

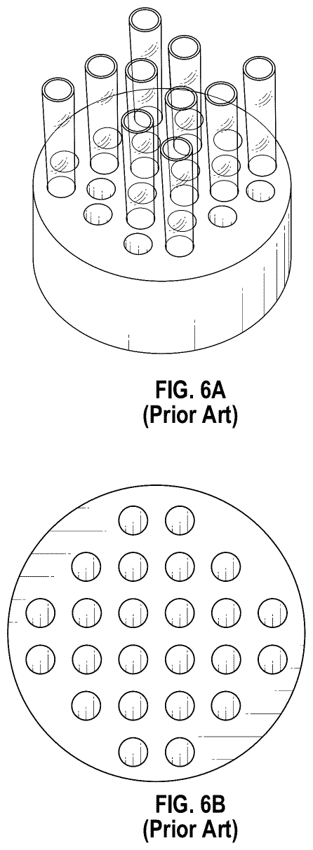

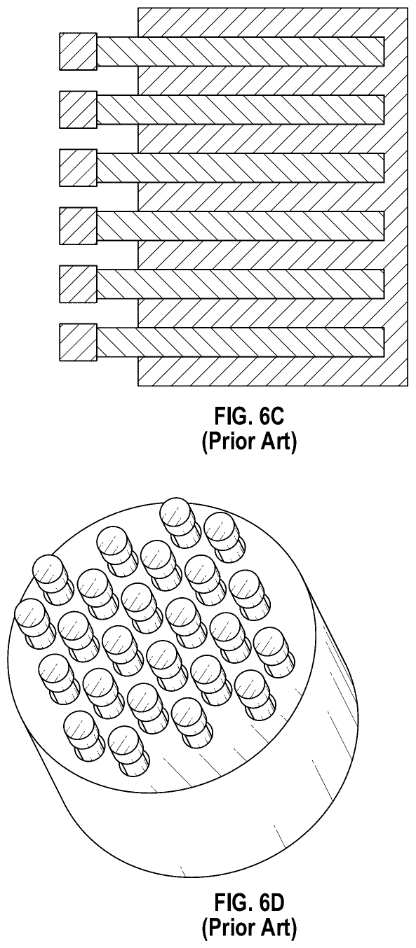

The existing art of test tube holders is limited in thickness and spacing between cavities. An example test tube holder in the prior art is displayed in FIG. 6A-6D with 24 cavities. The spacing between these cavities is ⅜″ thick. Additionally, if created in a molding machine, a taper must be applied so the part can be ejected from tooling. This means that the bottom of the cavity matches the test tube diameter of 0.44″. Since the cavity is tapered, the top opening is 0.54″. This results in potential movement of the test tubes and is partially responsible for the spacing between the test tubes; if the test tubes are positioned closer, the taper and movement of the test tubes will result in the tubes colliding. The taper and the higher inter-cavity spacing results in the ability to hold 24 test tubes. In contrast, trays formed by conventional means, which are limited in the degree of taper that may be formed, sacrifices article movement within each cavity and increases overall tray size.

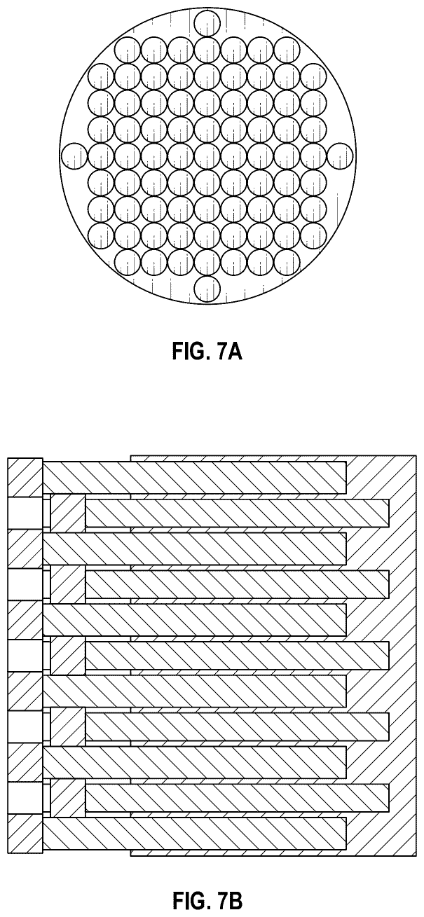

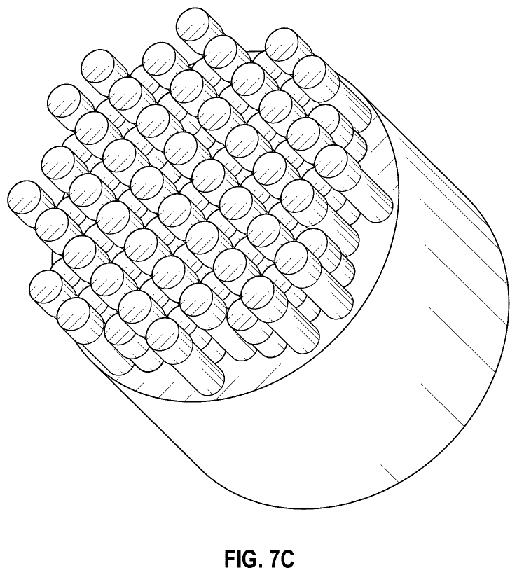

A molded bead-foam article was produced as described herein using PLA-based foam beads. Because of the ability for form cavities with varying depths, as described herein, and the ability to form cavities with 0° taper, and the ability to form walls between cavities of 1/16 inch or less with minimal impact to structural integrity, a test tube holder was formed with 81 test tube-sized cavities, over 300% more than the prior art. The schematic is depicted in FIGS. 7A-7C. The overall footprint of the test tube holder is the same as the one depicted in FIGS. 6A-6D.

### Example 5: Medical Vial Storage Trays with Varying Depths

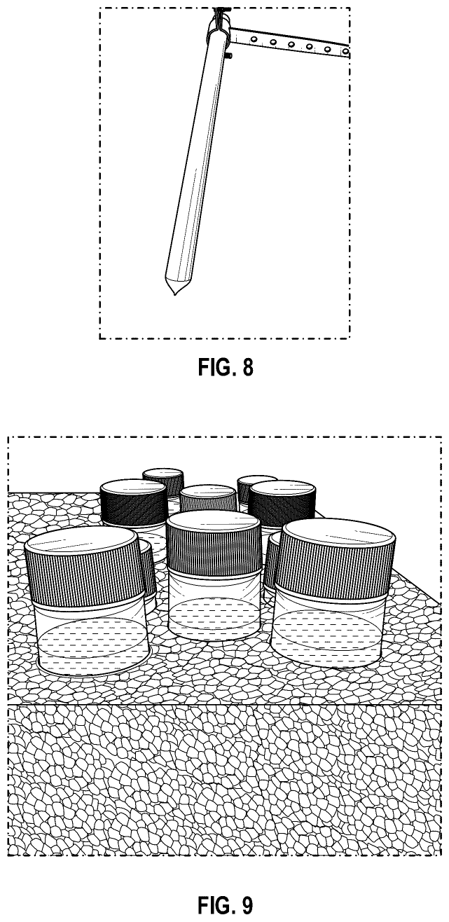

A molded bead-foam article was produced as described herein using PLA-based foam beads. 2.5- to 2.75-inch-deep cavities were formed using the hollow copper cylinder depicted in FIG. 8 having 0.75 inch diameter and an inter-cavity wall thickness of 0.125 inches. The 2.5 inch-deep cavities had a hydraulic diameter of 3.3, while the 2.75 inch-deep cavities had a hydraulic diameter of 3.6. The cavities were loaded with medical vials, with alternating cavities having a depth 0.25″ deeper. The results are displayed in FIG. 9. Although a single copper cylinder was used to form these exemplary articles, a plurality of similar cylinders may be used in a commercial setting as part of a platen.

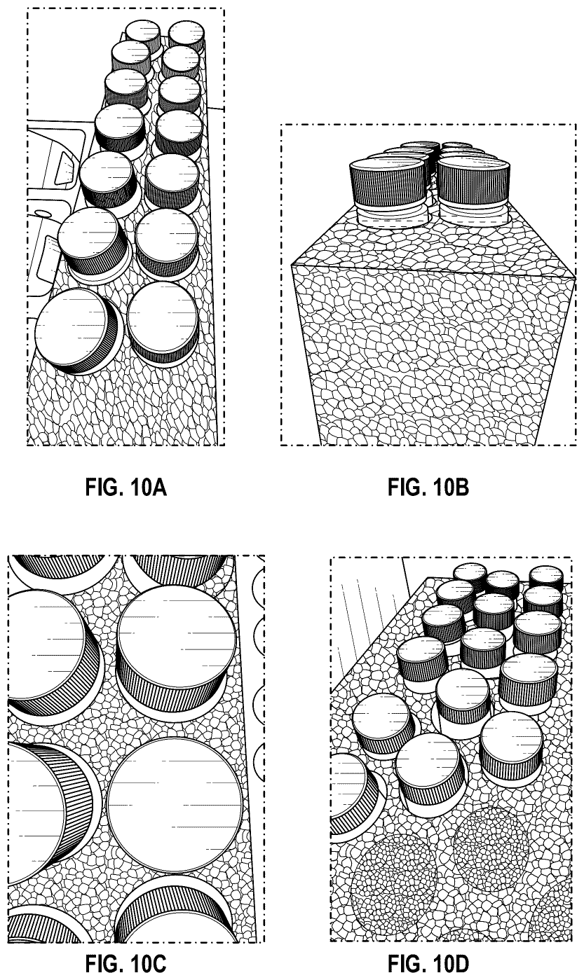

Another molded bead-foam article was produced as described herein using PLA-based foam beads. 4-inch-deep cavities were formed having 0.75 inch diameter and an inter-cavity wall thickness of 0.0625. The ratio of cavity depth to cavity diameter was 5.3. The cavities were loaded with medical vials. The results are displayed in FIGS. 10A-10D.

As demonstrated in Examples 3-5, cavities with varying depths and increased cavity density or storage capacity may be formed in a molded bead-foam article producing using PLA. This increases the number of products that may be shipped in a given article and may also enable the inclusion of multiple assorted products in a single article. For example, certain medical test kits require multiple different reagents that each come in a vial or plurality of vials and are typically shipped in multiple homogeneous packages. By forming the product packaging as described herein, every reagent necessary for a given test may be incorporated within a single product package, with cavity depth and diameter being adjusted as needed for the reagent vials themselves.

### Example 6: Formation of Cavities by Joining Separate Molded Bead-Foam Articles

Molded bead-foam articles were formed as described herein using PLA-based foam beads. Separate molded bead-foam articles were joined together by heating exposed edges and pressing the articles together.

A 2-inch tall “lattice” of ⅛-inch-thick walls was heated to 325° F. and adhered to a 1.5-inch-thick plank of foam. The cavity formed by the lattice is 2 inches by 2 inches with a skin-formed surface. Since conventional cavity forming methods in other foams require wall thickness of at least 0.5 inches, forming the molded bead-foam article as described in this example increases the number of cavities from 16 to 25, an increase of 56%. This increases the number of products that can be shipped in a given package, increases the number of products shipped in a given truckload, and reduces the carbon footprint of transportation, storage, and shelf space. Furthermore, there are also considerable savings when the trays are handled by operators and robots. The time for an operator or robot to pick up, move, fill, and sterilize can hasten the process by 40-60% by minimizing tray handling saving time, energy, and cost significantly.

Typical EPS-based bead-foam articles have cavities which are 2-3 times larger than the sidewall. For example, a cavity in an EPS-based article may be ⅞ inches wide may have a sidewall which is 5/16″ to 7/16″. By narrowing the sidewalls either by the creation of a lattice or with a skin-formed cavity, cavities can be produced which are 8 to 16 times larger than the sidewall, for example a cavity which is ⅞″ wide may have a sidewall which is only 1/16″ (14 times smaller than the width of the cavity). Table 1, below, demonstrates waste of space in a tray due to increased side wall thickness.

TABLE 1
Sidewall and Cavity Size Comparison between EPS and PLA

| | EPS | PLA | PLA | PLA |
|---|---|---|---|---|
| | Example | Example | Example | Example |
| Sidewall (in.) | 0.38 | 0.06 | 0.06 | 0.06 |
| Cavity (in.) | 0.88 | 0.50 | 0.88 | 1.00 |
| Wasted space due | 43% | 12.5% | 7.1% | 6.3% |
| to side walls | | | | |

An exemplary schematic demonstrating the sidewall-to-cavity size ratio for an 80-cavity PLA-based molded bead-foam article is depicted in FIG. 11A, while an 80-cavity EPS-based molded bead-foam article is depicted in FIG. 11B. As shown in these figures, forming the molded-bead-foam article from PLA significantly reduces the overall size of the packaging. Assuming a cavity size of 1 inch long and 0.25 inches wide, traditional EPS-based articles have a side-wall thickness of 0.375 inches while the PLA-based articles of the present invention have a side-wall thickness of 0.0625 inches. Thus, an 80-cavity EPS-based article has a length of 11.4 inches and width of 6.6 inches, while an 80-cavity PLA-based article has a length of 8.5 inches and a width of 3.2 inches. When loading a pallet with multiple trays, a pallet loaded with the trays of the present invention can hold 4,400 products, while a pallet with traditional trays can hold 1,680 products, an increase of 262%.

### Example 7: Producing High-Density Storage Trays from Ridged Panels

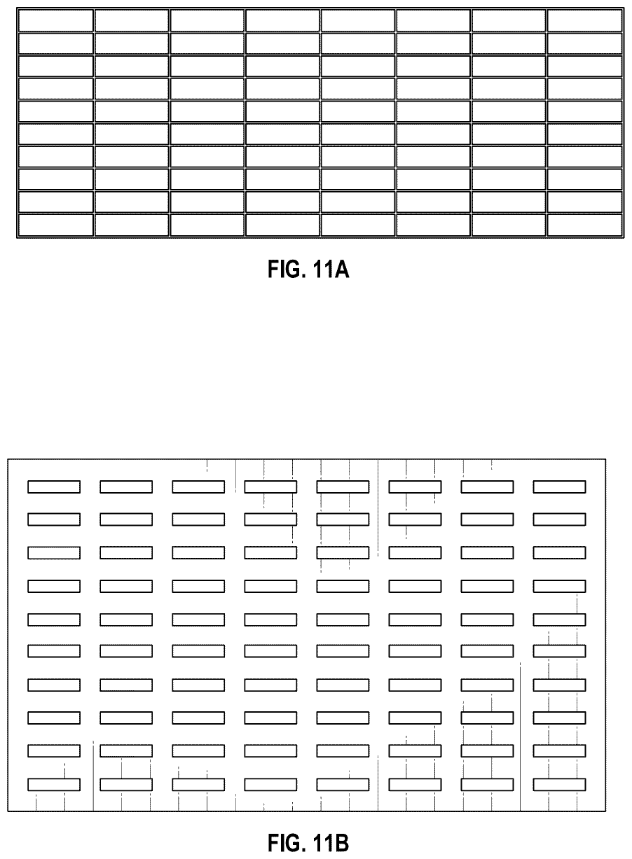

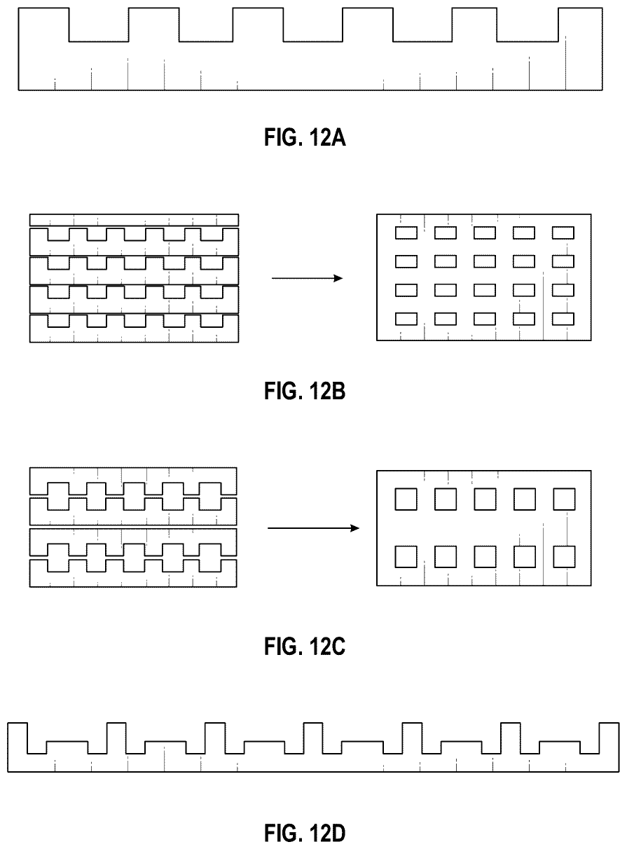

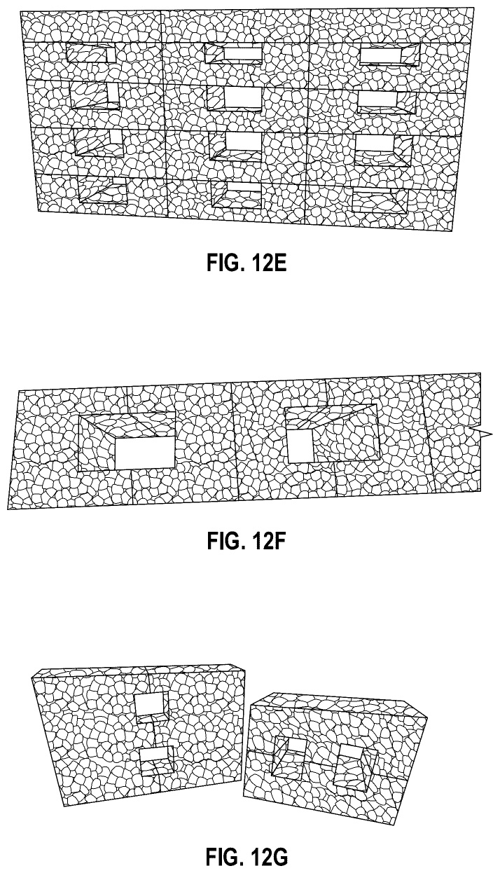

Molded bead-foam articles were produced as described herein from PLA-based foam beads. The articles were composed of a long “wall” piece with several ridges, as depicted in schematic form in FIG. 12A. Four of these articles were positioned next to one another and adhered by application of heat, and then “capped” with a single long molded bead-foam article, as depicted in FIG. 12B. In another test, four of these articles were positioned next to one another and adhered as depicted in FIG. 12C.

By molding a thin piece with ridge(s) on one or both sides or the molded article and then subsequently adhering those together can enable the formation of lattices. The attachment process can be repeated in any direction to create a tray with desired length and width. By forming the lattice pieces from PLA, the attachment of different foam pieces in the lattice is permanent and provides a robust, rigid support for each article stored within the tray without the need to supplement with external support, such as corrugate. Once a desired lattice size is achieved, a flat panel can be adhered at the base. This advantageously enables the formation of trays having any size, lower side wall taper, and a depth-to-hydraulic diameter ratio of 2.5 or greater by simply adhering more or fewer lattice pieces depending on the needs of the application. This is especially useful when adapting to two different pallet sizes without the use of additional molds or tools. For example, a single mold may be used to produce the lattice pieces which may be combined as needed to produce a wide range of tray sizes. This method with or without multiple cavity size can be ideal for display boxes on store shelves. Multiple cavity sizes can allow packaging items which are typically sold together. Furthermore, since cavities can be formed having varying depths, more complicated shapes can be produced such as the one depicted in FIG. 12D. Exemplary articles formed as described in this Example are presented in FIGS. 12E-12G.

### Example 8: Producing Retail and e-Tail Packaging

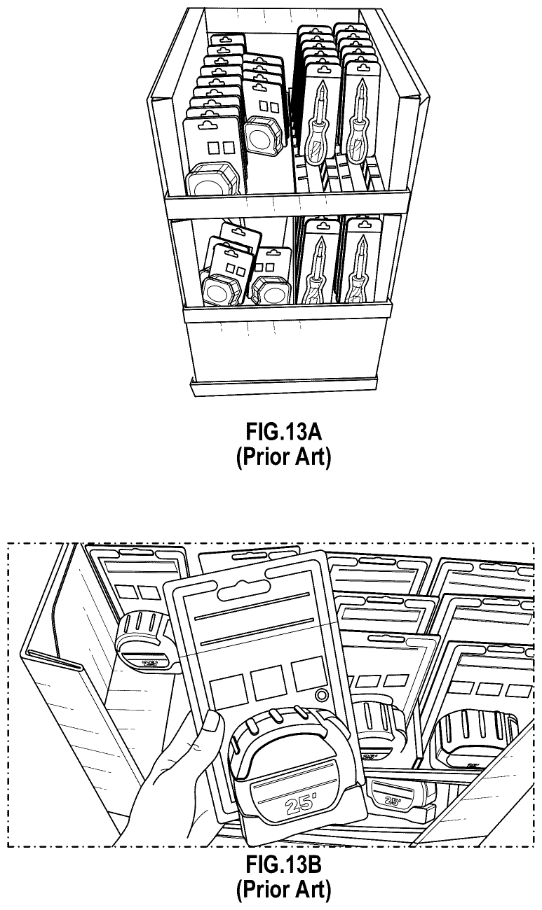

Current retail and e-tail packaging is bulky and hard to unpack, as displayed in FIGS. 13A and 13B. As AI-based theft deterrent systems and pick and place robots, such as autonomous moving multilevel shelves, become more common, the need for sustainability grows and new types of retail and e-tail packaging are necessary. Such packaging may include packaging which decouples article information functions of UPC code, product identification, and product feature list from protection of articles. Molded bead-foam articles as described herein may enable simple, light and compact film and label systems as the product feature package housed in PLA-based trays with thin walls and deep cavities to hold higher density of articles on a shelf. Including these in a single tray reduces the time necessary to hang or display a product on a shelf or rack in a store.

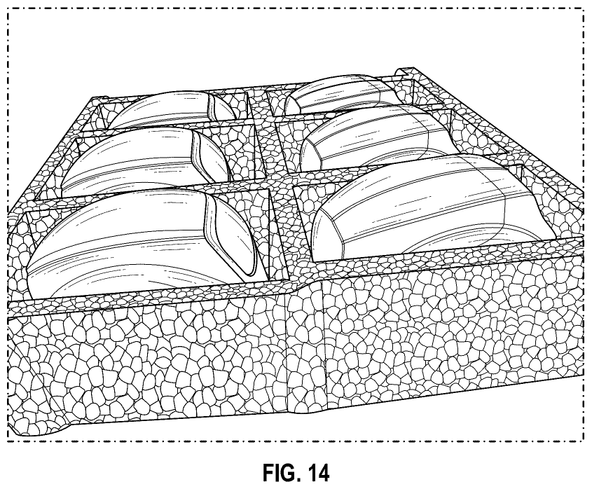

FIGS. 13A and 13B show display boxes common to “big box” stores where each article is in a secondary package made with plastic sheet and paper board. The bulkiness of both primary and secondary package limits the number of articles stored per unit volume of space. Thus, increasing the density of articles per linear foot of shelf space at a retailer is valuable. The trays with deep vertical cavities with thin inter-cavity wall thickness maximize product stored per linear foot of shelf space. Exemplary product packaging as described herein is displayed in FIG. 14.

FIG. 14 depicts exemplary packaging for tape measures. Tape measures' use and function are well understood by consumers, yet they are packed individually in a hybrid package using large blister cards and plastic packaging. This additional packaging increases the width of each package by 1″ in depth and nearly doubles the height. The individually packed tape measures are placed on a shelf or placed in a corrugated display with dividers. In FIG. 13A, there are twenty tape measures displayed in a corrugated tray that has a volume of 2,520 in³ (24″ length, 15″ width, and 7″ height). If trays were created as described herein, at least 60 tape measures (with 4″ length, 2.5″ width, and 3″ height being used to protect each tape measure) can be displayed in the same space. This space saving saves costs for shipping trays, since more trays could fit on a truck, it also saves time stocking shelves and maximizes valuable real estate on retail shelves.

Although tape measures are used in this example, there are many commodities and goods having well defined uses and functions, but they utilize packaging which is much larger with unnecessary product details. For example, an individually packaged drill bit with clam shell blister packaging has a shelf-space volume of 17 in³, while the drill bit itself only had a volume of 3.65 in³. This 465% increase in space reduces the quantity which can be shipped, stored on retail shelves, and can be stored in warehouses. The trays described herein can enable efficiencies in storage, shipping, loading and displaying many articles found in hardware and other big box retail stores. These trays can be useful for e-tail distribution as well. Smaller size packaging such as ⅕th the size described for drill bits allows e-tailer to use smaller boxes reducing carbon footprint of shipping and reducing costs associated with box and shipping.

### Example 9: Bead Gaps at Surface

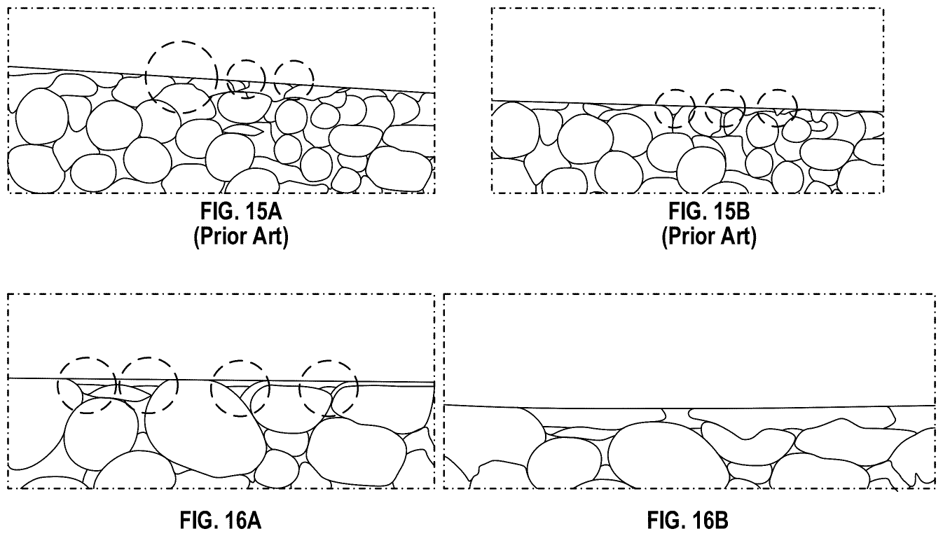

Surface roughness in molded bead-foam articles arise from gaps and voids which exist between beads. To minimize the gaps between beads and improve surface smoothness, a smaller bead size can be selected. EPS bead size ranges from 1-6 mm with 2-4 mm beads being used for most applications and 1 mm (t-size bead) being used in specialty equipment for applications which require the smoothest, even surface. However, even with 1 mm EPS bead being used, small gaps still exist between beads. FIG. 15A depicts an EPS-molded article formed from 3 mm beads, and FIG. 15B depicts an EPS-molded article formed from 1 mm beads. FIG. 16A, in contrast, depicts a PLA-based molded bead-foam article formed from 5 mm beads, while FIG. 16B depicts the PLA-based molded bead-foam article of FIG. 16A after cavity formation. As seen in FIG. 16B, cavity formation eliminates all gaps in between the beads to produce a smooth, dust-free, easily cleaned surface.

### Example 10: Surface Roughness Test Before and After Skin-Forming

Surface roughness tests were performed on molded foam articles as described herein. Transporting test tubes or other fragile items in a foam article having a low Rₐ (average roughness) results in a superior protection because the article is in consistent and constant contact with the walls of the tray. It is equally important that Rₘₐₓ (maximum roughness) is as low as possible as this measurement indicates sharp irregularities which are known to be equally detrimental to the article being protected. Finally, the haptic feedback of the cavities made of EPS (B/C-bead), EPS (T-bead) and PLA (skin-formed) lead to preference of PLA (skin-formed).

Roughness measurements were made using an Amtast® AMT211 Roughness tester, available commercially from Amtast USA Inc., Lakeland, Florida, United States. This device conforms to ISO, ANSI, DIN, and JIS standards.

The test was conducted according to ISO 4287: Geometrical Product Specifications and ISO 16610-21: Geometrical Product Specifications. The GAUSS (gaussian) filter (set by ISO 11562) was used which has a set amount of approach travel, pre-travel, assessment length, and then post-travel as well as returning back to the initial point before calculating surface roughness. The entire range of the test was 20 mm with the cut-off on either side is 0.8 mm. The range that the stylus can measure roughness in the z-axis is 320 μm (microns) with a tolerance of 0.08 μm.

The surface roughness gauge used had a stylus point which touched the material being measured and traced the surface at a constant rate. The machine acquired the surface roughness by the sharp stylus' contact since roughness of the article causes the stylus to be displaced up or down. As the stylus moved its position, the inductive value of induction coils inside of the sensor body sent an analogue signal to the machine which was collected and then analyzed based on the ISO tests mentioned above.

A total of 60 analyses were performed—4 tests per part and 3 parts for each material were conducted. Materials included: PLA, skin-formed PLA, EPS (B/C Bead), EPS (T bead), and Cellulose (corrugated board/molded pulp). The results are displayed in Table 2, with all units in microns (μm).

TABLE 2
Results of Roughness Measurement

| | Rₐ | Rₐ Std | Rₐ | Rₐ | Rₘₐₓ | Rₘₐₓ Std | Rₘₐₓ | Rₘₐₓ |
|---|---|---|---|---|---|---|---|---|
| Material | Average | Dev | Min | Max | Average | Dev | Min | Max |
| EPS (B/C) | 41 | 17.6 | 22 | 63 | 250 | 60 | 189 | 350 |
| EPS (T) | 15 | 6.1 | 10 | 24 | 193 | 69 | 90 | 233 |
| EPS (fine | 27 | 7.6 | 20 | 39 | 280 | 58 | 210 | 344 |
| machining) | | | | | | | | |
| PLA | 36 | 17.9 | 12 | 53 | 488 | 222 | 213 | 756 |
| PLA Skin-Formed | 5.0 | 2.0 | 2.1 | 9.2 | 71 | 31 | 29 | 107 |
| Cellulose (corrugated | 24 | 12.0 | 11 | 38 | 232 | 204 | 70 | 571 |
| board, pulp) | | | | | | | | |
| Plastic Injection | 1.7 | 0.4 | 1.4 | 2.0 | 12 | 0.13 | 12 | 12 |
| Molded | | | | | | | | |

As shown in Table 2, the surface roughness of the articles produced as described herein is lower than B/C-sized EPS beads and, when the PLA is skin-formed, the surface roughness is lower than the smallest EPS bead (T-sized). This skin-forming process is impossible with EPS-based foam articles; improving the surface roughness in these EPS articles can be achieved only through fine-machining. However, after the EPS surface is fine-machined, the EPS surface post-fine-machining is smoother than B/C bead EPS, but less smooth compared to T-sized bead. Thus, it is impossible to achieve the same surface roughness (or “smoothness”, as the case may be) with EPS-based molded articles without expensive, unconventional methods.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirit and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure is not to be seen as limited by the foregoing but is only limited by the scope of the appended claims.

That which is claimed is:

1. A bead-foam article formed from polylactic acid comprising:
a first plurality of cavities separated by a plurality of walls,
wherein a surface roughness of each cavity in the first plurality cavities is 10 microns or less without the use of subtractive machining.

2. The bead-foam article of claim 1, wherein the bead-foam article is composed of plurality of beads.

3. The bead-foam article of claim 1, wherein the thickness of at least one wall in the plurality of walls is less than 3 foam beads thick.

4. The bead-foam article of claim 1, wherein at least one wall in the plurality of walls has a taper of about 3° or less.

5. The bead-foam article of claim 1, wherein the thickness of at least one wall in the plurality of walls is ¼ inch thick or less.

6. The molded bead-foam article of claim 1, wherein at least one cavity in the plurality of cavities has a ratio of depth to hydraulic diameter of 2 or greater.

7. The molded bead-foam article of claim 1, wherein each cavity in the plurality of cavities has a cylindrical shape, rectangular shape, triangular shape, oval shape, or a shape matching an article disposed within the cavity.

8. The molded bead-foam article of claim 1, further comprising a skin-formed portion on a bottom of at least one cavity in the plurality of cavities and/or at least one wall in the plurality of walls.

9. The molded bead-foam article of claim 1, further comprising at least one product in each cavity,
wherein a packing density of the products is 20% greater than any comparable product produced by injection molding, molded pulp, bead foam molding, or thermoforming having at least 12 cavities.

10. The molded bead-foam article of claim 1, further comprising a second plurality of cavities, wherein the second plurality of cavities having a depth axis perpendicular to a depth axis of the first plurality of cavities.

11. The molded bead-foam article of claim 1, wherein at least one cavity in the first plurality of cavities has a first depth, and at least one cavity in the first plurality of cavities has a second depth different from the first depth.

12. The molded bead-foam article of claim 1, further comprising at least one grip portion having a depth axis perpendicular to a depth axis of the first plurality of cavities.

13. The molded bead-foam article of claim 1, further comprising at least one hole in a bottom of at least one cavity in the first plurality of cavities.

14. The molded bead-foam article of claim 1, further comprising at least one keyhole slot in a wall of at least one cavity in the first plurality of cavities.

15. The molded bead-foam article of claim 1, further comprising a supplementary molded foam feature attached to the molded bead-foam article.

16. The molded bead-foam article of claim 15, wherein the supplementary molded foam feature comprises one or more walls that form one or more additional cavities when attached to the molded bead-foam article.

17. A method of forming a molded bead-foam article, the method comprising:
molding a plurality of foam beads comprising polylactic acid, wherein the molding process comprises:
injecting the plurality of foam beads into a mold, and
subjecting the mold to an elevated temperature and reduced pressure to expand the foam beads;
wherein the molded bead-foam article is characterized by having a plurality of cavities separated by a plurality of walls,
wherein a surface roughness of each cavity in the first plurality cavities is 10 microns or less without the use of subtractive machining

18. The method of claim 17, wherein at least one wall in the plurality of walls has a taper of about 3° or less.

19. The method of claim 17, wherein the thickness of at least one wall in the plurality of walls is less than 3 foam beads thick.

20. The method of claim 17, wherein at least one cavity in the plurality of cavities has a ratio of depth to hydraulic diameter of at least 2.

21. The method of claim 17, wherein the plurality of cavities is at least partially formed by a plurality of corresponding cavity-forming structures in the mold.

22. The method of claim 17 further comprising pressing a shaped platen against the molded bead-foam article,
wherein the shaped platen comprises a plurality of cavity-forming structures, and
wherein the plurality of cavities is at least partially formed by the shaped platen.

23. The method of claim 22, wherein the shaped platen is heated before being pressed against the molded bead-foam article.

24. The method of claim 22, wherein the plurality of cavity-forming structures comprises about 400 cavity-forming structures.

25. The method of claim 22, wherein the plurality of cavity-forming structures comprises at least 20% more cavities than conventional high-density product packaging.

26. The method of claim 22, wherein less than 100 psi force is used to press the shaped platen against the molded bead-foam article.

27. The method of claim 17, further comprising forming a skin-formed portion on a bottom of at least one cavity in the plurality of cavities and/or at least one wall in the plurality of walls.

28. The method of claim 17, further comprising attaching one or more supplementary foam features to the molded bead-foam article to form one or more additional cavities.
